(19) United States
(12) Patent Application Publication
(10) Pub. No.: US 2004/0203587 A1
(43) Pub. Date: Oct. 14, 2004

(54) Apparatus and method for monitoring the time usage of a cellular telephone

(76) Inventor: Joseph A. Bekanich, Shavertown, PA (US)

Correspondence Address: McDERMOTT, WILL & EMERY, 600 13TH Street, N.W., Washington, DC, 20005-3096, US

(21) Appl. No.: 10/253,715

(22) Filed: Sep. 25, 2002

(51) Int. Cl. H04Q 7/28

(52) U.S. Cl. 455/407; 455/566; 455/550.1

(57) ABSTRACT

Apparatus for monitoring the time usage of a cellular phone to avoid over usage within a billing period, and thereby avoid unexpected high costs over and above the basic cost of the billing plan.

Three embodiments of the invention are disclosed for retrofitting standard commercial cells for the time monitoring function without interfering with normal operation of the cell phone.

### BACKGROUND OF THE INVENTION

This invention relates generally to wireless communication systems and more particularly to apparatus and method for monitoring and displaying time usage data for cellular phone service provided during a billing period.

Mobile cellular phone technology is one of the fastest growing sectors of today's global economy and it is expected that the use of cell phones will continue to grow dramatically in the future. Subscribers to cell phone service generally choose from a number of monthly billing packages offered by the cell phone service providers and those billing packages normally include a combination of various services which are geared to particular customer needs. For example, a billing plan may offer a certain amount of free time within a local area, a certain amount of free time of long distance calling out of the local area, reduced rates for different times of the day, graduated rates based upon volume usage and so forth Regardless of the billing package employed it has been said that more than half of the revenue or income obtained by the cell phone service providers is derived from over usage billing accounts through subscribers exceeding the usage time allowed by their basic billing plans. Clearly, a cell phone subscriber has a primary interest in tracking the amount of time his telephone is in use so as to avoid exceeding the time usage permitted under the basic billing plan and thereby avoid unexpected high monthly bills due to that over usage time which is normally billed at the highest rates.

Cell phones themselves are often programmed with an options menu including such features as access internet, phone book, call related features, messages, phone set up, network selection, and others. Some phones can display the length of time of a single call. However, presently there is no known commercial device which is either part of a standard cell phone or which may be used with a standard cell phone that allows a subscriber to monitor accrued talk time minutes used within a billing period so that the subscriber may avoid exceeding the number of minutes permitted by the basic billing plan and thereby avoid having to pay an unexpectedly large cell phone bill at the end of the month.

It should be understood that it is to the advantage of the cellular service provider not to afford the time usage monitoring function on the cell phones since, as mentioned above, a substantial part of their income is derived from the over usage billing by subscribers who have no idea what the status of their time usage is when they are exceeding the time allotted by their basic billing plan. Cellular service providers have a significant influence over the cell phone manufacturers and this may explain why the cell phones themselves, when originally manufactured, are not programmed to provide any total time or over usage information to the subscriber.

U.S. Pat. No. 5,684,861 discloses a rather complex, costly system for monitoring time usage of a cell phone but, to applicant's knowledge, neither that system nor any other system has been successfully commercialized.

The total time monitoring system of the invention as described hereinbelow was developed to satisfy the needs of the subscriber as discussed above.

### SUMMARY OF THE INVENTION

Accordingly the primary object of this invention is to provide monitoring or talk time managing systems that can be readily incorporated into standard cellular phones to provide a variety of time usage information to the subscriber at any time during a normal billing period.

Another object of the invention resides in the provision of the above novel systems which enable phone subscribers to monitor usage, programmable minutes, (child usage monitor), billing period information, minutes available, minutes used, minutes remaining, and to signal an alarm to notify the consumer approaching over usage. The novel systems operate without disrupting normal phone functions and 911 dialing which are initially programmed into the circuitry of the cell phone when the phone is manufactured

A further object of the invention is to provide the above novel systems which are manually operated, inexpensive, quickly installed into the phone and reliable in operation, to provide a time usage feature which supplements the various other features programmed originally into the phone.

Still another object of the invention is to provide the above novel systems as after market devices which can be readily installed into standard commercial cell phones without interfering with or disrupting normal phone functions. The only cost borne by a subscriber is the initial cost of the purchase of the devices, and there are no additional costs for their continued use.

The above objects of the invention are accomplished by providing several embodiments of the novel system which when retrofitted into a standard cellular phone enable the subscriber to quickly and easily obtain time usage information at any time during the monthly billing period.

Other objects and advantages of the invention will become apparent from reading the following detailed description of the invention wherein reference is made to the accompanying drawings.

### BRIEF DESCRIPTION OF THE DRAWINGS

FIG. 1 is a fragmentary front view of a first embodiment of the invention which includes a self-contained cover device including a battery operated programmable liquid crystal display (LCD), the device being attachable to the outside of an existing mobile phone;

FIG. 2 is a side view of the device taken along line 2-2 of FIG. 1;

FIG. 3 is a view similar to FIG. 2 illustrating the way in which the device is attached to the mobile phone;

FIG. 4 is a rear view of the device taken along line 4-4 of FIG. 2;

FIG. 5 is a schematic illustration of a flexible diaphragm switch which is part of the device of FIG. 1 and which covers the “send/talk” and “end” keys of the mobile phone;

FIGS. 6A through 6F illustrate a second embodiment of the invention in which a new talk time management (TTM) keypad and TTM faceplate are substituted for the original keypad and original faceplate on an original conventional phone to monitor the time usage of the phone without interfering with the functions which were originally programmed into the phone;

FIG. 7 schematically illustrates the switches provided in association with the “send/talk” or “end” keys of the new TTM keypad and the flat wire assembly leading from those switches to a battery operated programmable LCD timer and display on the TTM faceplate;

FIG. 8 illustrates a third embodiment of the invention in which a conventional mobile phone is provided with specific software designed to selectively override the software programmed originally into the existing LCD of the mobile phone so that talk time information may be made available to the subscriber;

FIG. 9 schematically illustrates a system for programming the new TTM software into the phone illustrated in FIG. 8;

FIG. 10 is a bottom view taken along line 10-10 of FIG. 8 illustrating the data ports normally provided on mobile phones which can be utilized to receive the programming information in the system of FIG. 9.

### DETAILED DESCRIPTION OF THE INVENTION

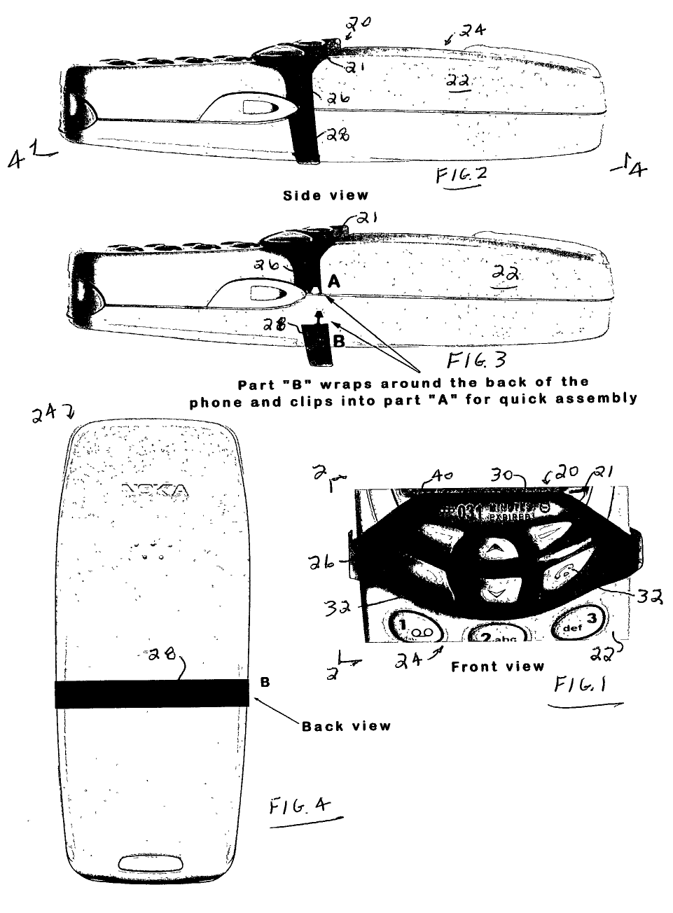

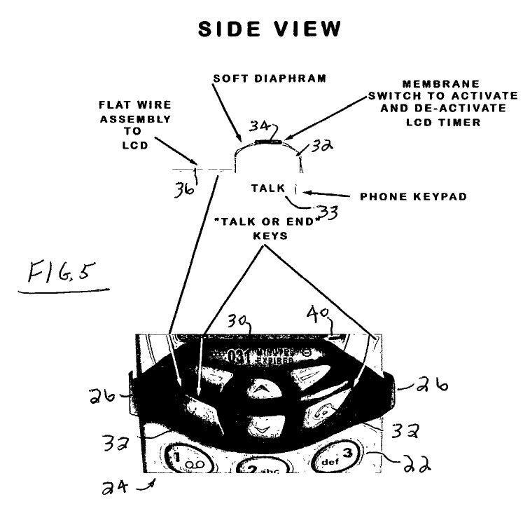

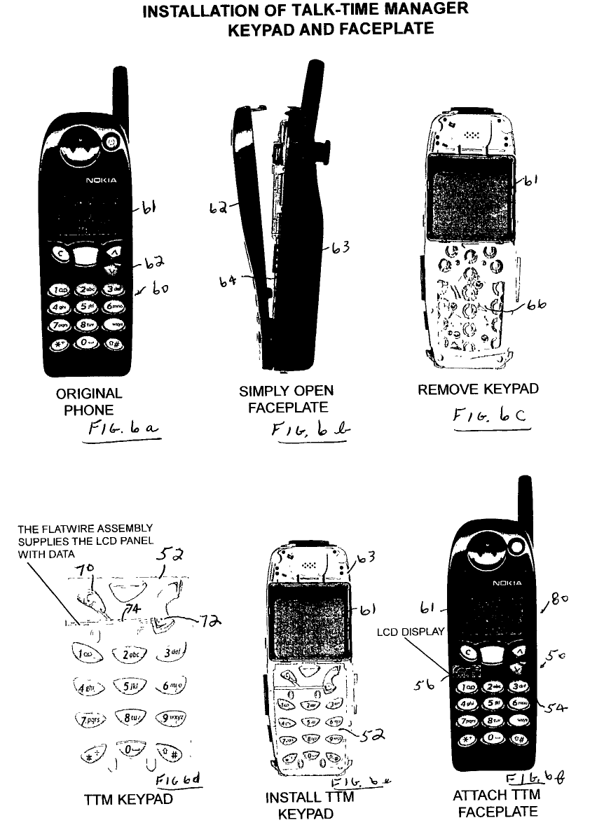

Referring now to FIGS. 1-5, a first embodiment of the invention includes a talk time managing (TTM) device 20 formed by a molded plastic cover 21 which mounts on the front faceplate 22 of a conventional standard cell phone 24, the cover 22 having side arms 26 which snap together with a strap 28 which passes around the body of phone 24 to hold cover 21 in place on the phone.

Mounted within cover 21 is a battery operated, programmable liquid crystal display (LCD) 30 which has been pre-programmed to monitor and display time usage information such as programmable minutes (child usage monitor), billing period information (date, month, year) minutes total, minutes remaining, minutes overage alarm, notify the consumer of set program usage through selected tones or alarms, time/LCD clock (date, month and year) and any other time usage information. A soft flexible diaphragm button 32 is mounted on cover 21 and overlies each of the “send/talk” and “end” keys 33 on the keypad of the cell phone and protruding through faceplate 22. Each of the buttons 32 includes a membrane switch 34 connected by way of a flat wire 36 to LCD 30 so as to activate or de-activate the LCD timer 30 when the “send/talk” and/or “end” keys are depressed to initiate or end the conversation using the phone.

The self-contained manually operated TTM 20 is simple in construction, inexpensive, reliable, and quickly installed on the phone, and it does not interfere with the existing functions or information displayed on the LCD 40 which is normally part of the cell phone 24.

As a result the TTM device 20 can be sold as an after market product and then readily attached to a standard cell phone 24 to provide a subscriber with valuable time usage information so that the subscriber can avoid exceeding the times allotted by his basic billing plan and thereby avoid having to pay excessive over usage charges under that billing plan. The only cost incurred by a subscriber is the original purchase price of device 20. There is no charge for the continued use of the device.

As already mentioned attachment of TTM device 20 onto the outside of faceplate 22 does not interfere with or block the usage of any of the functions or features which are normally provided on a standard cell phone 24.

Each time the soft diaphragm button 32 and the normal send/talk button 33 are depressed to activate the phone LCD the time clock is activated to record the total talk time in minutes used until the end key is activated and the call is terminated. The total talk time is continually added each time the talk and end keys are pushed, thus giving a running total of talk time minutes used. The LCD display 30 is programmed to provide not only the total talk time used but also to inform the subscriber of other desirable information such as the programmable minutes, the billing information, minutes available, minutes used, minutes remaining and to signal an alarm to notify the subscriber when the total minutes available under the billing plan have been exceeded.

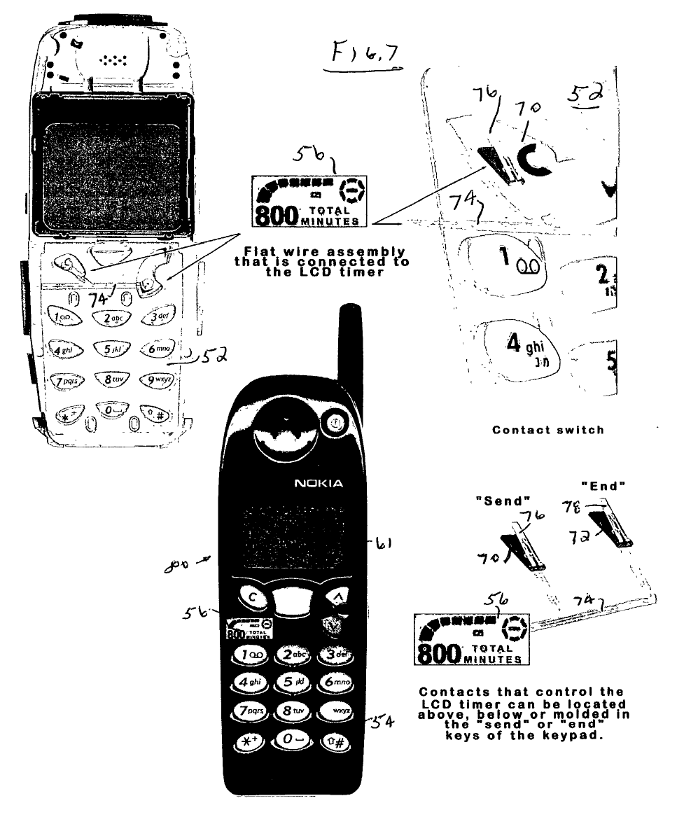

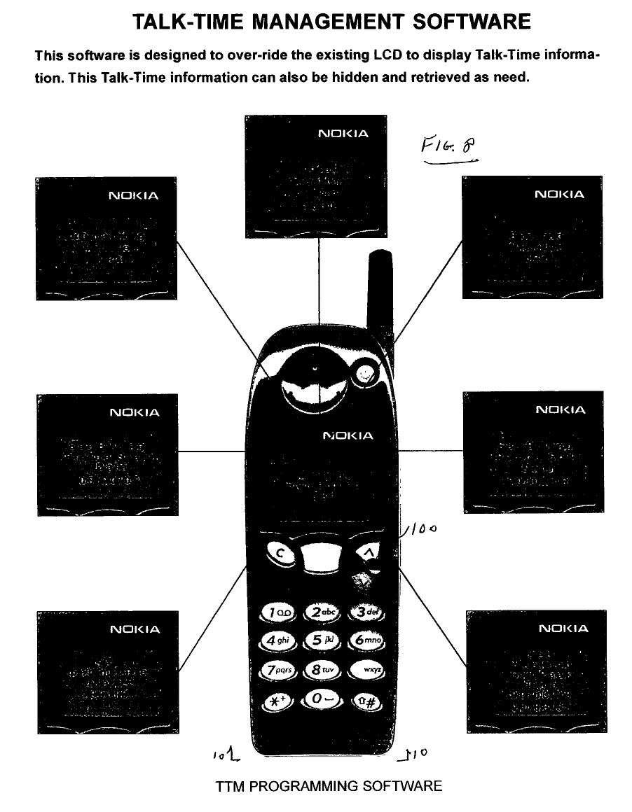

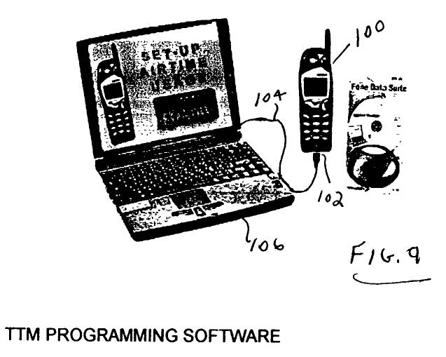

Referring now to FIGS. 6A through 6F and FIG. 7, a second embodiment of the invention includes a talk time manager assembly 50 having a novel TTM keypad 52 (FIG. 6D) and a novel TTM faceplate 54 (FIG. 6F) which has a programmable LCD display 56 mounted within.

Keypad 52 and faceplate 54 are constructed so as to fit a particular conventional phone, for example the Nokia phone 60 illustrated in FIG. 6A. To do this, the conventional faceplate 62 and keypad 64 are removed from base 63 of phone 60 as illustrated in FIGS. 6B and 6C. The rest of the phone remains in tact within base 63 including the original display 61 and operating circuitry 66 as shown in FIG. 6C so that the various functions and features offered with the original phone 60 are not disturbed.

The faceplate 54 is identical to the original faceplate 64 except for the LCD display 56 mounted within faceplate 54.

The TTM keypad 52 of FIG. 6D may be identical to the original keypad 64 provided in phone 60 except that the send key 70 and end key 72 have associated therewith switches 76 and 78 which will be connected to the LCD display 56 of the TTM faceplate 54 by way of the flat wire assembly 74 mounted directly on TTM keypad 52 when keypad 52 and faceplate 54 are assembled on base 63.

Once the original faceplate 62 and keypad 64 are removed, TTM keypad 52 is mounted in base 63 as shown in FIG. 6E in place of the original keypad. Finally as shown in FIG. 6F, TTM faceplate 54 is snapped into place on base 63. As shown in FIG. 7, with TTM keypad 52 and TTM faceplate54 assembled on the base 63, the LCD timer 56 on faceplate 54 is connected via flat wire assembly 74 to micro switches 76 and 78 mounted on send and end keys 70 and 72, respectively.

Consequently, when the send key 70 is pushed down to initiate usage of the phone switch 76 is also closed to activate the LCD timer 56 which continues to run until the end key 72 and end switch 78 are pushed down The LCD display 56 adds up the total time minutes used for all conversations and, as in the embodiment of FIG. 1, provides talk time information to the subscriber as described hereinabove to avoid over usage and unexpected high billings for the particular billing period.

As with the TTM device 20 of the first embodiment of the invention, the components 52 and 54 of assembly 50 are quickly and easily assembled on the body of a conventional phone once the original faceplate and keypad are removed therefrom. Assembly 50 then provides a talk time management function without disturbing the features and functions of the phone originally programmed into the initial original circuitry 66 when the phone was manufactured. Thus, the time management information displayed to a subscriber by LCD 56 is totally separate from and supplements the information displayed on the original display 61.

Thus, the TTM assembly 50 is installed on the body 63 of an original phone 60 to provide a manually operated, enchanced phone 80 which not only provides all of the functions of the original phone 60 but also affords the subscriber with the talk time information accumulated and displayed by LCD 56. Assembly 50 is manually operated in conjunction with the normal manual operation of the send and end keys of the cell phone and it is inexpensive, reliable, quickly installed and it does not interfere with the normal operation of the phone. It is however invaluable to a subscriber in that it enables the subscriber to keep track of the total time used and/or remaining under his billing plan and thus enables him to avoid additional expensive billing due to over usage. Again, the only cost borne by the subscriber is the initial cost of the purchase of assembly 50, and there are no additional costs for their continued use.

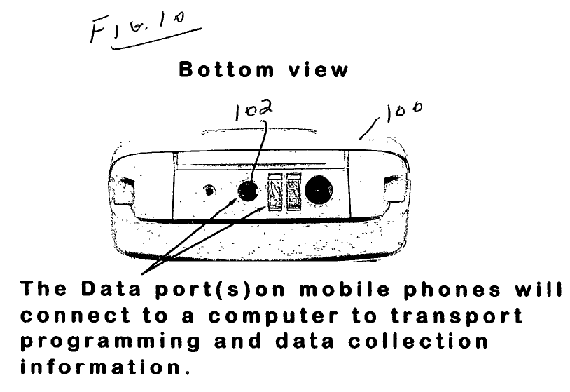

Referring now to FIGS. 8 through 10, a third embodiment of the invention includes specific talk time and management software which is programmed directly into a conventional cell phone 100 to provide the various time minutes information discussed above and illustrated in FIG. 8. The program may be installed by way of a system illustrated in FIG. 9 which includes the cell phone 100 which has at least one data port 102 connected by way of a cable 104 to a computer 106 which is loaded with the select program that is to be installed in the cell phone 100. Alternatively, the program may be installed by a wireless system employing for example, satellites.

As with the previous embodiments of the invention, cell phone 100 may be programmed to selectively display or hide the billing period, minutes available, minutes used, minutes remaining and to signal an alarm to notify the consumer the set usage or program usage.

The software embodiment can be particularly useful for businesses having a large number of employees who have been provided with cell phones and who normally have very little understanding of control over the time usage of the phone until the bills are received at the end of the billing period. A business may periodically use the computer 106 to check each of the cell phones 100 that are in the field to gain knowledge of the actual usage within a billing period and therefore try to cut down on the actual usage during the remaining period and thereby avoid outrageous bills at the end of the period.

It is apparent that the various embodiments of the invention as described above satisfy the objectives initially set forth hereinabove and provide cell phone subscribers with time usage systems that help avoid excessive over billing at the end of a billing period.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. Apparatus for monitoring usage of a cellular telephone having a faceplate, a keypad having a plurality of keys including send/talk and end keys, said apparatus comprising a cover adapted to be attached to the cellular telephone and extend over at least a portion of the faceplate, first and second actuating switch means mounted on said cover and overlying said send/talk and end keys, respectively, programmable means mounted on said cover for measuring and displaying time usage information relating to a particular billing plan, and circuit means on said cover connecting said switch means to said programmable means, said first and second switch means activating and deactivating said programmable means when the send/talk and end keys, respectively, are pressed so that the programmable means may display the total time the telephone is used during a billing period.

2. The apparatus of claim 1, wherein said programmable means includes a liquid crystal display.

3. The apparatus of claim 2, wherein the programmable means may display at least one additional function selected from programmable minutes, billing period information, minutes total, minutes remaining, minutes overage alarm, and actual time.

4. The apparatus of claim 1, each of said first and second switch means including a flexible diaphragm which permits the send/talk and end keys to be depressed.

5. The apparatus of claim 1, wherein said programmable means does not interfere with normal operation of the cellular telephone.

6. Apparatus for monitoring usage of a cellular telephone which has a body, an original keypad mounted within said body, an original faceplate, connected to the body and covering the original keypad, said apparatus comprising a talk time managing faceplate including programmable means mounted thereon for measuring and displaying time usage information relating to a particular billing plan, a talk managing time keypad having send/talk and end keys, said talk time keypad and faceplate being configured so as to permit their substitution for the original keypad and faceplate, respectively, on the body, first and second switch means associated with said send/talk and end keys, respectively, and circuit means on said talk time keypad connecting said switch means to said programmable means when said talk time keypad and faceplate are assembled on the body, said first and second switch means activating and deactivating said programmable means when said send/talk and end keys, respectively, are pressed so that said programmable means may display the total time the telephone is used during a billing period.

7. The apparatus of claim 6, wherein said programmable means includes a liquid crystal display.

8. The apparatus of claim 7, wherein the programmable means may display at least one additional function selected from programmable minutes, billing period information, minutes total, minutes remaining, minutes overage alarm, and actual time.

9. The apparatus of claim 6, wherein said programmable means does not interfere with normal operation of the cellular telephone.

10. A system for monitoring the time usage of a cellular telephone through a billing period, the telephone having already been preprogrammed to provide other functions, the system comprising a software program containing time and billing information relative to a billing plan, means for loading said software into the cellular telephone so that a subscriber may review current time usage status during the period, and wherein said software does not interfere with normal operation of preprogrammed functions of the cellular telephone.

11. The apparatus of claim 10, wherein said loading means is a computer.

12. The apparatus of claim 10, wherein said software enables the display of at least one time information selected from total minutes available, expired minutes, and remaining minutes under the billing plan.
